(19) United States
(12) Patent Application Publication
(10) Pub. No.: US 2016/0304268 A1
(43) Pub. Date: Oct. 20, 2016

(54) SELF-ADJUSTING CONTAINER

(71) Applicant: Malissa Schneider, Hamburg, NY (US)

(72) Inventor: Malissa Schneider, Hamburg, NY (US)

(21) Appl. No.: 15/098,943

(22) Filed: Apr. 14, 2016

Related U.S. Application Data
(60) Provisional application No. 62/147,069, filed on Apr. 14, 2015.

(51) Int. Cl. B65D 83/00; B65D 25/56; B65D 21/08; A01K 29/00; A01K 5/00

(52) U.S. Cl. CPC B65D 83/0038; A01K 29/00; A01K 5/00; B65D 21/08; B65D 25/56

(57) ABSTRACT

A dispenser for pet food kibble or other loose material, where a floor panel of adjustable elevation is contained within the dispenser. The floor panel is supported by a spring that adjusts the height of floor panel in response to removal or addition of material. The spring automatically adjusts to maintain the level of material at a constant elevation. The floor panel is sealed with a gasket to prevent material from falling into the chamber below. A transparent window in the front of the container allows a user to view the amount of material left in the container to determine when the container may be refilled. The opening of the container may have a shape approximate to that of a standard bag of material to be used in the dispenser. The spring may be surrounded by a telescoping rod to prevent buckling under the increased weight of material.

This application claims the benefit of U.S. provisional application 62/147,069 filed Apr. 14, 2015.

### FIELD

The present disclosure relates to an adjustable dispenser for loose material, such as food products, where a container within the dispenser includes a mechanism to raise the level of the container during use.

### BACKGROUND

Pet food dispensers or containers are commonly stored on the floor in a closet or pantry. Pet owners typically pour dry food kibble from a large bag into such dispensers for storage and use because a bag of dry pet food kibble is unwieldy and prone to spilling after it has been ripped open. Pet owners prefer to place the entire contents of the bag into the storage container to maintain freshness and eliminate the need to store transport and dump the contents of an opened bag of food.

After transfer of the kibble from the bag to the dispenser, the kibble is removed from the dispenser in portions upon feeding. After each feeding, the level of the pet food kibble in the dispenser decreases. Therefore, as the level of the kibble decreases after multiple feedings, a pet owner is often required to bend over to an uncomfortable degree in order to reach the top surface of the kibble with the removal container. For certain individuals, bending over to reach the food can present health risks including sprains, muscle tears or pain, and may be impossible for individuals with certain medical conditions, including pregnancy.

Prior references includes methods of raising containers that rest on a table or floor for ease of use, however, all of these require manual operation to change the level. For example, U.S. Pat. No. 8,627,987 discloses a container having an adjustable base, however, the base is adjusted manually through a set of inter-engaging thread elements attached to the base so that relative rotation of the inter-engaging thread elements causes upward movement of the base. In other words, a user has to turn a knob to adjust the level of the container to make dispensation of the product easier. In the process described in the '987 patent, the top surface level of the loose material in the container lowers as material is removed. Only when the user decides to raise the container manually is does the top surface of the loose material return to the optimal elevation level. Manually adjusting the level of a container requires effort by the user, particularly when the contents of the container are heavy.

Therefore, there is a need for a pet food dispenser that automatically adjusts the level of the surface of the dry pet food kibble to an optimal height upon removal of pet food.

### SUMMARY

The method and apparatus of the present disclosure describes to a spring operated dispensing device wherein the volume of the within the four sidewalls and the floor panel decreases proportionately with the weight of the loose material removed such that the volume of the inner compartment of the container which contains the loose material decreases in equal proportion to the volume of the loose material removed.

In the preferred embodiment of the present disclosure, the loose material is pet food kibble. The present disclosure provides for a method including: removing a loose material from a container, lifting a floor panel automatically in response to the removal of the loose material such that the upper surface of the loose material remains at a constant vertical level regardless of how much loose material is removed from the container. No manual operation by the user is required and the elevational level of the loose material in the container never changes.

The calibrated compression spring is a spring that is calibrated to adjust as weight is removed or added, such that the supporting spring changes length an equal in proportion to the weight or volume of the supported material removed. Springs placed under significant weight have a tendency to buckle. To solve this problem, the present disclosure has included telescoping rods that surround the spring to prevent buckling.

The transparent window in the front of the loose material dispenser allows a user to determine how much material is inside the container at any given time. The window extends vertically from approximately the bottom of the dispenser to the upper lip, and is generally rectangular in shape, with the length of the rectangle approximately equal in length to the dispenser.

The present disclosure relates to apparatuses and methods for maintaining the level of loose material, such as pet food kibble, at a constant level as material is removed from the container.

### BRIEF DESCRIPTION OF THE DRAWINGS

FIGS. 1A-C show a top perspective view of the pet food dispenser with varying amounts of kibble in the container;

FIG. 2 shows a top perspective view of the pet food dispenser showing an empty container and illustrating the transparent window;

FIG. 3 shows a cross-sectional view of the pet food dispenser showing two springs and gaskets at the perimeter of the floor panel;

FIG. 4 shows a sectional view of the dispenser illustrating the floor panel, the springs, the transparent window and a partially open top;

FIG. 5 shows a perspective view of one embodiment of the pet food dispenser having telescoping rods surrounding the spring.

### DETAILED DESCRIPTION

Particular embodiments of the present disclosure are described hereinbelow with reference to the accompanying drawings. In the following description, well-known functions or constructions are not described in detail to avoid obscuring the present disclosure in unnecessary detail.

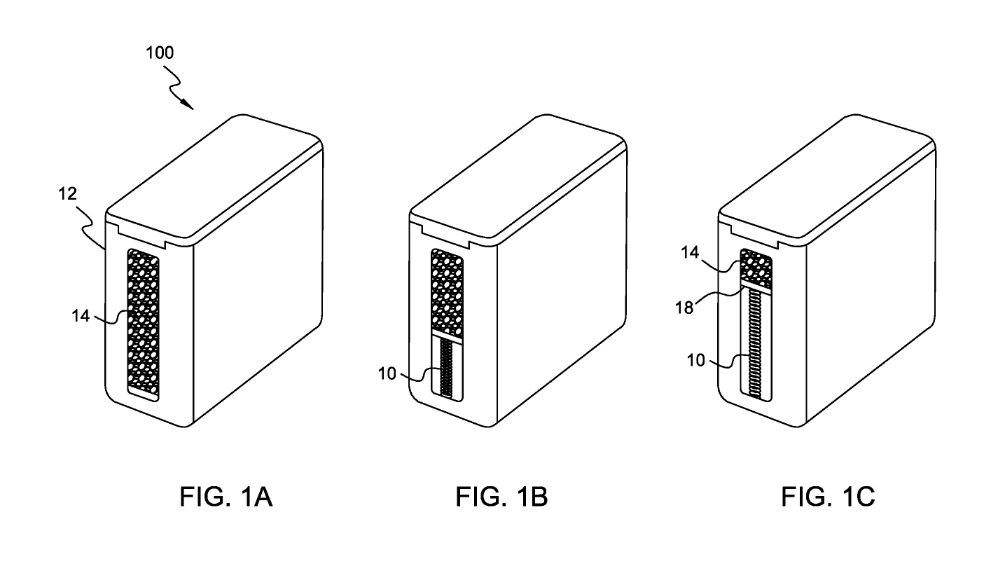

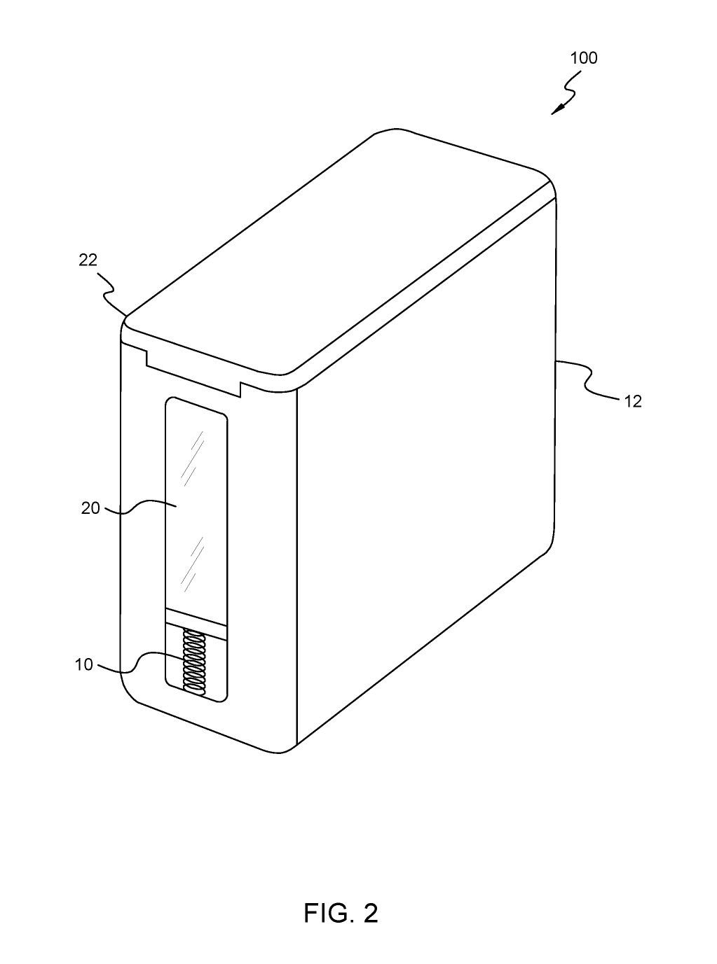

With reference to FIGS. 1A-C, a top perspective view of the pet food dispenser shows varied amounts of kibble in the dispenser 100, as evident through a transparent window 20 (shown in FIG.2). The spring 10 extends automatically to raise floor panel 18 as pet kibble 14 is removed from the container 12, which contains kibble 14 and consists of sidewalls and floor panel 18. The spring 10 is illustrated in various states of compression. The top of dispenser 100 is preferably at the approximate elevation of an adult person's waist, such that the top surface of kibble 14 is maintained at the level most convenient for reaching into container 12 and scooping out kibble 14.

In some embodiments the spring 10 may be a tension spring or a calibrated compression spring. In one embodiment of the present disclosure, the springs were selected to be calibrated to maintain the top surface of the pet food at a constant height. The approximate dimensions of one embodiment of dispenser 100 are 24 inches in height, 18 inches in length and 12 inches in width. The approximate weight of floor panel 18 is 1 lb. The spring 10 is 18″ in length when fully extended and at rest, the outside diameter of the coil is 2 inches, and the inside diameter is 1½ inches. The thickness/gauge of the spring is ¼ inches. The compression is approximately 25 lbs. /1 inch.

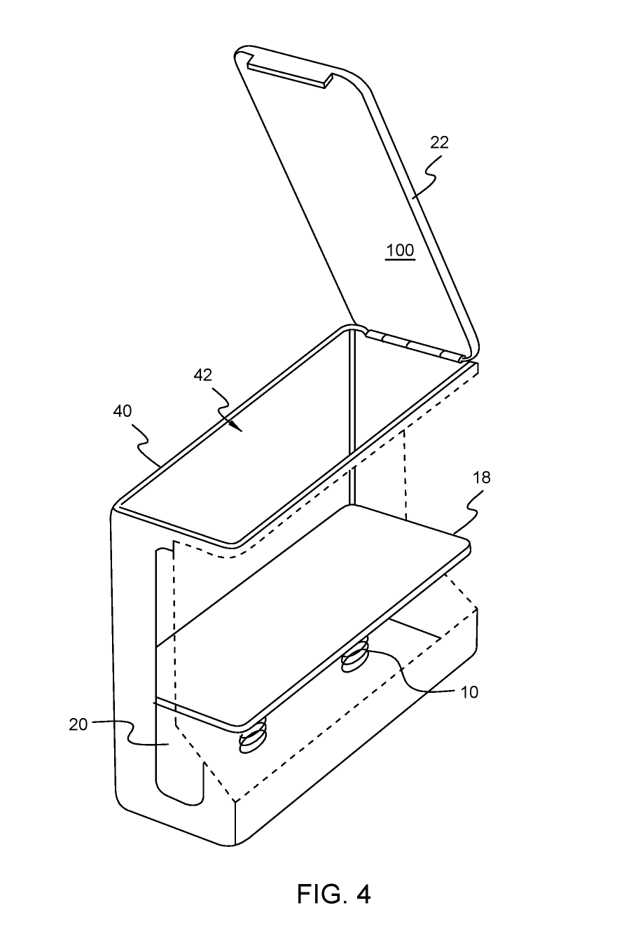

In one embodiment of the present disclosure, a calibrated compression spring is used. The calibrated spring is designed based upon the specific variables of the pet food dispenser, including the dimensions of the container 10, such as height, width and length, the weight of kibble 14, the weight of floor panel 18 and any friction that may exist between floor panel 18 and sidewall 32 (shown in FIG. 4). When designing a calibrated spring there are a number of spring parameters that are factored into the design, including, diameter width (thickness or gauge), outer diameter (overall width), free length (overall length), and the number of active coils. A calibrated spring may also have a closed and ground ends to the spring so that it can be mounted flat to the top and bottom.

The calibrated compression spring 10 is adapted to hold predetermined materials, such as kibble 14, at predetermined levels at its upper end and to raise material such as kibble 14 to predetermined levels commensurate with their weights and to be compressed by increased weight to predetermined levels.

In one embodiment, the weight of typical dry pet food kibble 14 is approximately 4 ounces per cup. As each cup is removed the spring raises level floor panel 18 a distance concomitant with the amount of kibble 14 removed to maintain the top surface of the kibble 14 at a constant level approximately level with sidewall upper lip 40 (shown in FIG. 4).

Due to the inconvenience of carrying, pouring from and storing an open bag of dry pet food kibble 14, the container 12 of dispenser 100 may have a size and shape similar to that of standard sized bags of pet food. Particularly, the opening surrounded by upper lip 40 (shown in FIG. 4). When spring 10 is fully compressed, the spring 10 may be calibrated and customized to have a container approximate to the dimensions of a preferred size bag of pet food kibble 14. A pet owner typically purchases a single brand and size of food appropriate for their pet, and therefore, according to the present disclosure, an appropriate size dispenser 100 and spring 10 may be purchased for that brand and size.

With reference to FIG. 2, a top perspective view of the self-adjusting container 100 of the present disclosure shows the transparent window 20 which allows a user to view the amount of kibble in the container. The front portion of container 100 includes a transparent window 20, which may be generally rectangular in shape and approximately the overall shape of dispenser 100. The transparent window 20 allows a user to determine how much kibble 14 is inside container 12 at any given time. The transparent window 20 extends vertically from approximately the bottom of the dispenser to the upper lip 40, and is generally rectangular in shape, with the length of the rectangle approximately equal in length to the dispenser.

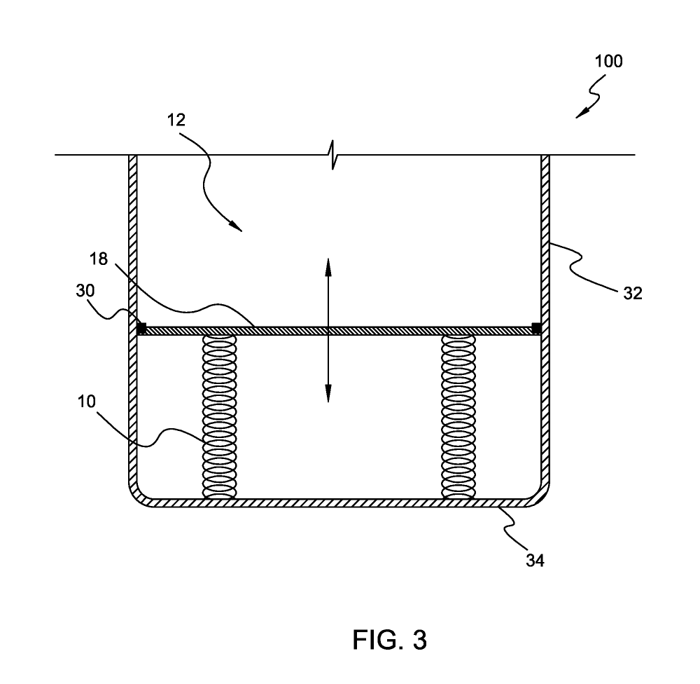

With reference to FIG. 3, a cross-sectional view shows two springs 10 in a partially expanded state. FIG. 3 also illustrates a gasket 30 that comprises a narrow flexible band enclosing the circumference of floor panel 18 creating a seal from the floor panel 18 to the inside of the container sidewall 32. Gasket 30 contacts both the upper surface of floor panel 18 and sidewall 12 and rises and lowers with floor panel 18. Gasket 30 forms a seal between sidewall 32 and floor panel 18 in order to prevent loose material such as pet food kibble 14 crumbs from falling into the chamber below containing the spring 10. Container 12, in some embodiments, may be tapered for manufacturing purposes, whereupon a 2 degree taper may be needed to reduce draft upon completion of the mold. The seal may be a ¼ arch. The gasket 30 may alternatively be a pliable rubber seal or a flexible material.

With reference to FIG. 4, a sectional view shows the top surface of floor panel 18 with the springs 10 in a partially compressed state. To reach a compressed state shown in FIG.4, the springs 10 would have kibble 14 (not shown) filling the space between floor panel 18 and the sidewall upper lip 40 of sidewall 32 of container 12. The container opening 42 allows for kibble 14 to be poured into the container 12. The opening 42 may preferably be size and shaped to accept a standard ratio of length and width of a large bag of dry pet food kibble 14. For example, a manufacturer of product for pet food bags, Newtec Bag Palletizing, lists on their website a set of standard pet food bag dimensions, showing that pet food bags typically have a length and width for large pet food bags where the length is approximately 2 to 3 times the width.

### Technical Data:

| Product | Pet-food |
|---|---|
| Bag weight & dimensions | Bags 4 kg - 720 × 375 × 105 mm |
| 8 kg - 570 × 250 × 140 mm | |
| 10 kg - 750 × 375 × 130 mm | |
| 15 kg - 910 × 375 × 150 mm | |
| 24 kg - 950 × 370 × 120 mm | |

mewtchttp://www.newtecbag.com/en/markets/agricultural-food/pet-food-bag-palletizing-line/

Therefore, the container 12 for dispenser 100 may have a similar ratio of length to width to allow for insertion of the pet food bag into opening 42 when spring 10 is fully compressed, while conserving space to store the dispenser 100 in a closet or the like. The feature of self-leveling of the present disclosure would generally accommodate the contents different weight pet food bags without the need for manual adjustment, while maintain the opening ratio to accommodate various weights of food, as evident from the chart above.

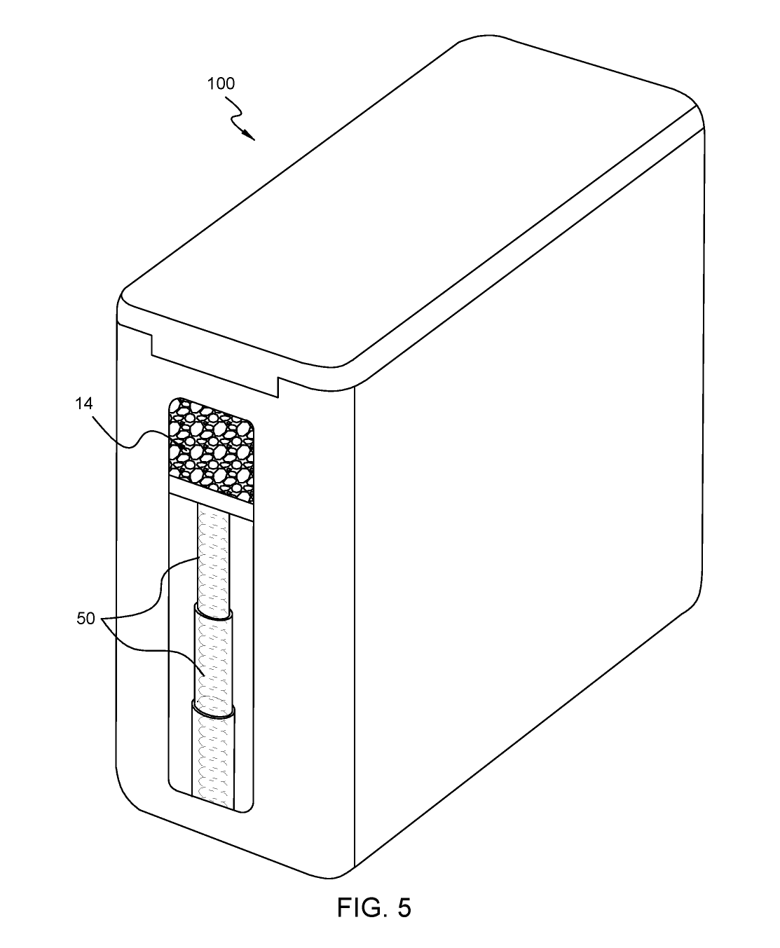

With reference to FIG. 5, one embodiment of the present disclosure includes a telescoping rod 50 surrounding the calibrated compression spring 10 to prevent the spring from buckling. Telescoping rod 50 may be comprised of a transparent plastic tubing or the like. The rod 50 may also be comprised of metal, plastic or any suitable material sufficient for preventing the spring 10 from buckling. There may be an elastic means to hold the rod 50 together or to maintain rod 50 in contact with the spring 10, or allow for expansion of spring 10 with increases in supported weight due to addition of kibble 14.

The rod segments may have lips, or connectors, at the ends to connect each rod segment and prevent rod segments from separating, while allowing the rod segments to freely collapse upon each other; while the upper most rod may permanently affix to a top coil or the lower portion of the floor panel. The means of holding the telescoping rod segments together could be circumferential protrusions, or lips, or other connection means as would be known in the art of telescoping rods.

The telescoping rod 50 may have a minimum diameter greater than the diameter of the fully compressed spring 10 and be of such diameter that as the diameter of the spring 10 widens the telescoping rod 50 accommodates for the increase in diameter of the turns of the spring 10 as its length decreases with increased weight from material. The rod 50 may be connected to the lower surface of floor panel 18 and may also be connected to the base 34 (shown in FIG.3) of dispenser 100.

While preferred embodiments of this disclosure have been described above and shown in the accompanying drawings, it should be understood that applicant does not intend to be limited to the particular details described above and illustrated in the accompanying drawings, but intends to be limited only to the scope of the disclosure as defined by the following claims. In this regard, the term “configured” as used in the claims is intended to include not only the designs illustrated in the drawings of this application and the equivalent designs discussed in the text, but it is also intended to cover other equivalents now known to those skilled in the art, or those equivalents which may become known to those skilled in the art in the future.

I claim:

1) A loose material dispenser comprising:
a floor panel surrounded by substantially rigid upstanding sidewalls terminating at a first end at an upper lip for receiving a lid and terminating at a second end at a base wherein said base is proximate to a floor; the floor panel being generally in contact with and held between said sidewalls; the floor panel and sidewalls together defining a container; wherein the floor panel is elevationally movable therein; and
a support for the floor panel residing between said base and said floor panel;
wherein said support is configured to provide variable amounts of force to the floor panel such that a top surface of the loose material is elevationally fixed.

2) The dispenser of claim 1, wherein the support is an at least one spring.

3) The dispenser of claim 1, wherein the support is an at least one calibrated compression spring.

4) The dispenser of claim 1, wherein an upper lip of the dispenser is approximately level with a waist of an adult person.

5) The dispenser of claim 1, wherein the support is a counterbalancing compression spring connected at a spring first end to a base and connected at a spring second end to an underside of the floor panel.

6) The dispenser of claim 1, further including a transparent window extending from approximately the base to approximately an upper lip of the dispenser.

7) The dispenser of claim 6, wherein the transparent window is comprised of a plastic material.

8) The dispenser of claim 1, wherein a length, width and height of the dispenser are configured to be approximate in size to a length, width and height of a bag of pet kibble.

9) The dispenser of claim 1 wherein a length of an opening of the container is approximately between 2 and 3 times that of a width of the opening of the container.

10) The dispenser of claim 1, further including a lid hingedly attached to the container wherein the lid is substantially in contact with an upper lip to sealingly contain loose material within said container.

11) The dispenser of claim 1, wherein the dispenser is configured to maintain an elevational level of an upper surface of the loose material approximately level with a waist of an adult person for providing an efficient location for the person to reach into the container to scoop out loose material.

12) The dispenser of claim 1, wherein a perimeter of the floor panel contains a gasket to prevent loose material from falling between the floor panel and the sidewalls.

13) A method comprising:
placing a loose material in a container of a dispenser for storage, wherein said container has a floor panel and sidewalls; wherein the sidewalls surround and enclose a perimeter of said; wherein said container has a spring beneath the floor panel;
simultaneously lowering the floor panel automatically in response to the addition of the loose material such that an upper surface of the loose material remains at a constant elevational level;
removing the loose material from the container; and
simultaneously raising the floor panel automatically in response to the removal of the loose material such that the upper surface of the loose material remains at a constant elevational level.

14) The method of claim 13, wherein as the loose material is removed from the container, a volume of space contained within the sidewalls, the floor panel and an upper lip of the container decreases in an amount equal to a volume of the loose material removed from the container.

15) The method according to claim 13, wherein the adjustable support is a spring.

16) The method of claim 13, wherein the adjustable support is a calibrated compression spring.

17) The method of claim 13, wherein the spring is the spring is supported by a guide comprised of a telescoping rod.

18) The method of claim 13, wherein the dispenser has a transparent window in a front side to allow a user to view an amount of loose material in the container.

19) The method of claim 13, further comprising calibrating a compression spring to provide self-leveling for a customized size bag of pet food kibble.

20) The method of claim 13, further comprising sizing a length and width of a container opening to match a length and width of a bag of pet kibble.
